(19) United States
(12) Patent Application Publication
(10) Pub. No.: US 2024/0294411 A1
(43) Pub. Date: Sep. 5, 2024

(54) AEROBIC GRANULE FORMING METHOD AND AEROBIC GRANULE FORMING DEVICE

(71) Applicant: ORGANO CORPORATION, Tokyo (JP)

(72) Inventors: Masaki MIYAKE, Tokyo (JP); Yoshiaki HASEBE, Tokyo (JP); Hizuru WAKAYAMA, Tokyo (JP); Kazuki FURUSAWA, Tokyo (JP)

(73) Assignee: ORGANO CORPORATION, Tokyo (JP)

(21) Appl. No.: 18/574,522

(22) PCT Filed: Jun. 22, 2022
(86) PCT No.: PCT/JP2022/024913

§ 371 Date: Dec. 27, 2023

(30) Foreign Application Priority Data
Jun. 30, 2021 (JP) 2021-109041

(51) Int. Cl. C02F 3/12; C02F 101/30

(52) U.S. Cl. CPC C02F 3/12; C02F 2101/30; C02F 2203/006

(57) ABSTRACT

The present disclosure is an aerobic granule forming method using a semibatch-type reaction tank (10) for forming aerobic granules, the aerobic granule forming method being characterized in that: the organic substance includes an easily decomposable organic substance and a slowly decomposable organic substance; and the time of the biological treatment process is adjusted so that the value obtained by multiplying the ratio of the MLSS concentration in the semibatch-type reaction tank (10) to the BOD loading volume of the easily decomposable organic substance in the semibatch-type reaction tank (10) by [time of the operating cycle/time of the biological treatment process] is in the range of 0.05-0.25 kg BOD/kg MLSS/day.

### TECHNICAL FIELD

The present disclosure relates to a method for forming aerobic granules and an apparatus for forming aerobic granules.

### BACKGROUND

Conventionally, an activated sludge process utilizing aggregates of microorganisms referred to as a floc (or aerobic biological sludge) has been used for biological wastewater treatment of treating wastewater that contains organic matter and the like. However, in the activated sludge process, in separating the floc (or aerobic biological sludge) and treated water in a sedimentation tank, there are cases where the surface area of the sedimentation tank must be made very large due to a low settling velocity of the floc. Further, although the treatment rate with the activated sludge process depends on the sludge concentration in the biological treatment tank and the rate can be increased by increasing the sludge concentration, if the sludge concentration is increased to the range of 1500 to 5000 mg/L or higher, solid-liquid separation becomes difficult due to bulking or the like occurring in the sedimentation tank, and situations may result where treatment cannot be maintained.

In anaerobic biological treatment, it is common to utilize aggregates referred to as granules (or anaerobic biological sludge), in which microorganisms are densely aggregated into granular form. Since the granules have a very high settling velocity and are such that the microorganisms are densely aggregated, the granules make it possible to increase the sludge concentration in the biological treatment tank and achieve high-rate treatment of wastewater. However, in comparison with aerobic treatment (or the activated sludge process), anaerobic biological treatment may in some cases have problems in that the target types of wastewater to be treated are limited and that the water temperature in the reactor needs to be maintained high at about 30 to 35° C. Furthermore, use of anaerobic biological treatment alone may produce treated water having poor quality, and when the treated water is to be discharged into a river or the like, post aerobic treatment like the activated sludge process may need to be additionally performed.

In recent years, it has been found that granulated biological sludge with good settling property can be formed not only with anaerobic biological sludge but also with aerobic biological sludge, by performing treatment using a semi-batch treatment apparatus in which wastewater is fed intermittently into a reaction tank, and by reducing the settling time of the biological sludge (see, for example, Patent Literature 1 to 4). By granulating aerobic biological sludge, an average particle size of 0.2 mm or larger and a settling velocity of 5 m/h or higher can be achieved. In semi-batch treatment, it is common to repeat, in one biological treatment tank, the following four processes of: (1) feeding wastewater: (2) performing biological treatment of organic matter: (3) allowing settling of biological sludge; and (4) discharging treated water.

Further, Patent Literature 5 discloses a semi-batch treatment method in which the following three processes are repeated: (1) feeding wastewater and discharging treated water: (2) performing biological treatment of organic matter; and (3) allowing settling of biological sludge.

### CITATION LIST

### Patent Literature

Patent Literature 1: WO 2004/024638 A
Patent Literature 2: JP 2008-212878 A
Patent Literature 3: JP 4975541 B
Patent Literature 4: JP 4804888 B
Patent Literature 5: JP 2016-77931 A

### SUMMARY

### Technical Problem

Conventionally, when organic matter to be biologically treated includes a large amount of slowly degradable organic matter, there are cases where formation of aerobic granules does not proceed easily.

Accordingly, an object of the present disclosure is to provide an aerobic granule forming method and an aerobic granule forming apparatus which are capable of stably forming aerobic granules even when a large amount of slowly degradable organic matter is contained the wastewater.

### Solution to Problem

The present disclosure provides an aerobic granule forming method using a semi-batch reaction tank in which aerobic granules are formed by performing an operation cycle including: a feed process of feeding organic matter-containing wastewater; a biological treatment process of biologically treating organic matter in the wastewater with microbial sludge; a settling process of allowing settling of the microbial sludge; and a discharge process of discharging treated water that has been subjected to the biological treatment. The organic matter includes readily degradable organic matter and slowly degradable organic matter. A duration of the biological treatment process is adjusted such that a value obtained when a ratio of the MLSS concentration in the semi-batch reaction tank relative to the BOD load of the readily degradable organic matter in the semi-batch reaction tank is multiplied by [a duration of the operation cycle/the duration of the biological treatment process] is in the range of 0.05 to 0.25 kg-BOD/kg-MLSS/day.

In the aerobic granule forming method, a ratio of the BOD concentration of the slowly degradable organic matter in the organic matter-containing wastewater relative to the total BOD concentration of the organic matter-containing wastewater fed into the semi-batch reaction tank is preferably 0.5 or higher.

In the aerobic granule forming method, it is preferable that a biologically treated water outlet of the semi-batch reaction tank is provided at a position higher than a wastewater inlet, and that the biologically treated water is discharged from the outlet by feeding the organic matter-containing wastewater into the semi-batch reaction tank from the wastewater inlet.

Further, the present disclosure provides an aerobic granule forming apparatus having a semi-batch reaction tank in which aerobic granules are formed by performing an operation cycle including: a feed process of feeding organic matter-containing wastewater; a biological treatment process of biologically treating organic matter in the wastewater with microbial sludge: a settling process of allowing settling of the microbial sludge; and a discharge process of discharging treated water that has been subjected to the biological treatment. The organic matter includes readily degradable organic matter and slowly degradable organic matter. The apparatus includes a means for adjusting a duration of the biological treatment process such that a value obtained when a ratio of the MLSS concentration in the semi-batch reaction tank relative to the BOD load of the easily degradable organic matter in the semi-batch reaction tank is multiplied by [a duration of the operation cycle/the duration of the biological treatment process] is in the range of 0.05 to 0.25 kg-BOD/kg-MLSS/day.

Further, the present disclosure provides a wastewater treatment method, including supplying aerobic granules formed by the above-described aerobic granule forming method to a continuous biological treatment tank for biologically treating organic matter-containing wastewater with biological sludge while continuously feeding the organic matter-containing wastewater.

Further, the present disclosure provides a wastewater treatment apparatus, including: a continuous biological treatment tank for biologically treating organic matter-containing wastewater with biological sludge while continuously feeding the organic matter-containing wastewater; and a means for supplying, to the continuous biological treatment tank, aerobic granules formed by the above-described aerobic granule forming apparatus.

### Advantageous Effects of Invention

According to the present disclosure, it is possible to provide an aerobic granule forming method and an aerobic granule forming apparatus which are capable of stably forming aerobic granules even when a large amount of slowly degradable organic matter is contained in organic matter-containing wastewater.

### BRIEF DESCRIPTION OF DRAWINGS

FIG. 1 is a schematic configuration diagram showing an example of an aerobic granule forming apparatus according to an embodiment of the present disclosure.

FIG. 2 is a schematic configuration diagram showing a further example of an aerobic granule forming apparatus according to an embodiment of the present disclosure.

FIG. 3 is a schematic configuration diagram showing a further example of an aerobic granule forming apparatus according to an embodiment of the present disclosure.

FIG. 4 is a schematic configuration diagram showing a further example of an aerobic granule forming apparatus according to an embodiment of the present disclosure.

FIG. 5 is a schematic configuration diagram showing an example of a wastewater treatment apparatus according to an embodiment of the present disclosure.

FIG. 6 is a graph showing changes over days in SVI and sludge average particle size in Comparative Examples.

FIG. 7 is a graph showing changes over days in SVI and sludge average particle size in Examples.

### DESCRIPTION OF EMBODIMENTS

Embodiments of the present disclosure will be described below. The embodiments are examples implementing the present disclosure, and the present disclosure is not limited to the embodiments.

### <Aerobic Granule Forming Method and Apparatus>

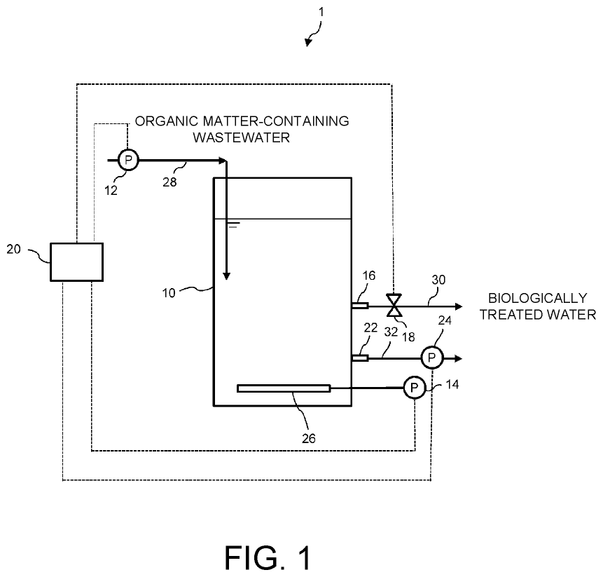

An outline of an example aerobic granule forming apparatus according to an embodiment of the present disclosure is shown in FIG. 1, and configuration thereof will now be described. The granule forming apparatus 1 comprises a semi-batch reaction tank 10. In the granule forming apparatus 1, a wastewater supply pipe 28 is connected to a wastewater inlet of the semi-batch reaction tank 10 via a wastewater feed pump 12. A biologically treated water pipe 30 is connected to a biologically treated water outlet 16 of the semi-batch reaction tank 10 via a biologically treated water discharge valve 18, and a sludge removal pipe 32 is connected to a sludge removal port 22 via a sludge removal pump 24. An aeration device 26 connected to an aeration pump 14 is installed at a lower part of the interior of the semi-batch reaction tank 10.

The granule forming apparatus 1 comprises a control device 20. For example, the control device 20 is constituted of: a microcomputer composed of a CPU for calculating programs, and a ROM and a RAM for storing the programs and calculation results: electronic circuitry; and the like. The control device 20 reads out a predetermined program stored in the ROM or the like, and executes the program to control operation of the granule forming apparatus 1. The control device is, for example, electrically connected to each of the wastewater feed pump 12, the biologically treated water discharge valve 18, the sludge removal pump 24, and the aeration pump 14, and controls actuation and stopping of the pumps, opening and closing of the valve, and the like.

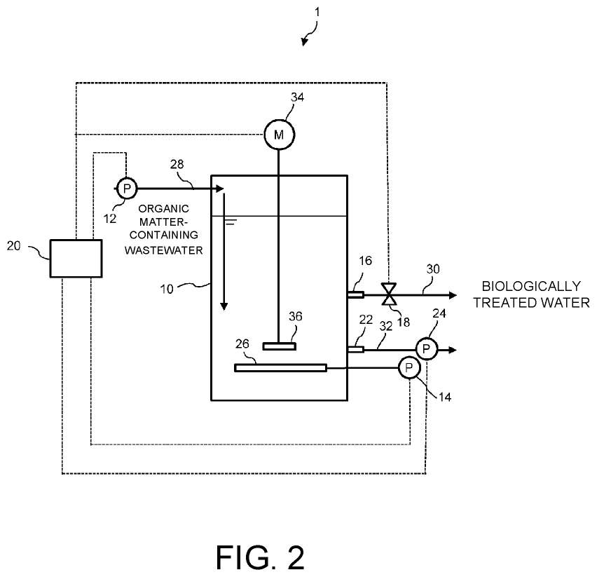

The granule forming apparatus 1 is operated, for example, in a cycle described as follows.
(1) Feed process: The wastewater feed pump 12 is actuated, and a predetermined amount of organic matter-containing wastewater is fed into the semi-batch reaction tank 10 through the wastewater supply pipe 28.
(2) Biological treatment process: The wastewater feed pump 12 is stopped, and oxygen-containing gas such as air is supplied from the aeration pump 14 to the semi-batch reaction tank 10 through the aeration device 26. In the semi-batch reaction tank 10, target substances to be treated such as organic matter in the organic matter-containing wastewater are biologically treated with microbial sludge. The biological reaction is not limited to an aerobic reaction. It is possible to perform an anoxic reaction by stirring without supplying air or the like, and an aerobic reaction and an anoxic reaction may be combined. An anoxic state refers to a state in which dissolved oxygen is absent but oxygen such as that derived from nitrate or nitrite is present. For example, as shown in FIG. 2, a stirring device composed of a motor 34, a stirring blade 36, a shaft connecting between the motor 34 and the stirring blade 36, and the like may be installed in the semi-batch reaction tank 10, and with the aeration pump 14 in a stopped state, stirring may be performed using the stirring device. It should be noted that the stirring device is not limited to those having the configuration described above.
(3) Settling process: The aeration pump 14 is stopped, and the sludge inside the semi-batch reaction tank 10 is allowed to settle by leaving to stand for a predetermined duration.
(4) Discharge process: By opening the biologically treated water discharge valve 18, supernatant water obtained in the settling process is discharged as biologically treated water from the biologically treated water outlet 16 and through the biologically treated water pipe 30. At that time, instead of using the biologically treated water discharge valve 18, a pump may be used to discharge the biologically treated water.

By repeating the operation cycle including the above processes (1) to (4), aerobic granules (hereinafter simply referred to as granules) are formed, which are aggregates in which microorganisms are densely aggregated into granular form.

The granules formed in the semi-batch reaction tank 10 are sludge that has undergone self-granulation, and are biological sludge having, for example, a sludge average particle size of 0.2 mm or larger, or an SVI5, which is an index of settling property, of 80 mL/g or less. In the present embodiment, whether or not granules have been formed is determined, for example, by measuring SVI, which is an index of sludge settling property. More specifically, it can be determined that granules have been formed at the stage when a value of SVI5 measured periodically by a settling property test performed on the sludge in the semi-batch reaction tank 10 has reached a predetermined value or less (for example, 80 mL/g or less). Alternatively, it can be determined that granules have been formed at the stage when the particle size distribution of the sludge in the semi-batch reaction tank 10 is measured and indicates that the average particle size has reached a predetermined value or larger (for example, 0.2 mm or larger). (It should be noted that when the SVI value is less and when the average particle size is larger, it can be determined that better granules are formed.)

The BOD load in the semi-batch reaction tank 10 is calculated by multiplying the BOD concentration of organic matter-containing wastewater fed into the semi-batch reaction tank 10 by the amount of the organic matter-containing wastewater. The BOD concentration is a value determined from the amount of oxygen consumed by microorganisms when decomposing organic matter over 5 days. Here, the organic matter in the organic matter-containing wastewater includes: slowly degradable organic matter, which takes several tens of hours to several days to be biodegraded by microorganisms; and readily degradable organic matter, which takes several hours to several tens of hours to be biodegraded by microorganisms. Accordingly, the BOD concentration can be classified into: the total BOD concentration corresponding to the amount of oxygen consumed by microorganisms when decomposing the organic matter including the slowly degradable organic matter and the readily degradable organic matter; the BOD concentration of slowly degradable organic matter corresponding to the amount of oxygen consumed by microorganisms when decomposing the slowly degradable organic matter; and the BOD concentration of readily degradable organic matter corresponding to the amount of oxygen consumed by microorganisms when decomposing the readily degradable organic matter. The total BOD concentration is the sum of the BOD concentration of slowly degradable organic matter and the BOD concentration of readily degradable organic matter.

Accordingly, the BOD load in the semi-batch reaction tank 10 can be classified into: the total BOD load based on the total BOD concentration (i.e., the total BOD concentration×the amount of organic matter-containing wastewater): the BOD load of slowly degradable organic matter based on the BOD concentration of slowly degradable organic matter (i.e., the BOD concentration of slowly degradable organic matter x the amount of organic matter-containing wastewater); and the BOD load of easily degradable organic matter based on the BOD concentration of readily degradable organic matter (i.e., the BOD concentration of easily degradable organic matter×the amount of organic matter-containing wastewater). The total BOD load is the sum of the BOD load of slowly degradable organic matter and the BOD load of readily degradable organic matter.

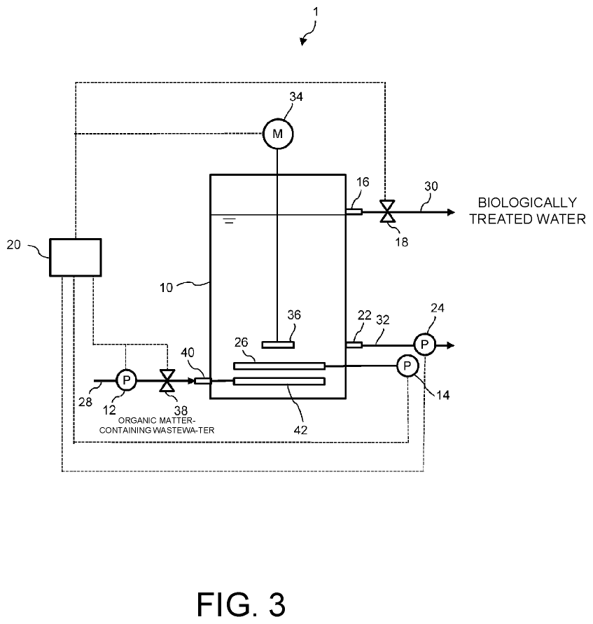

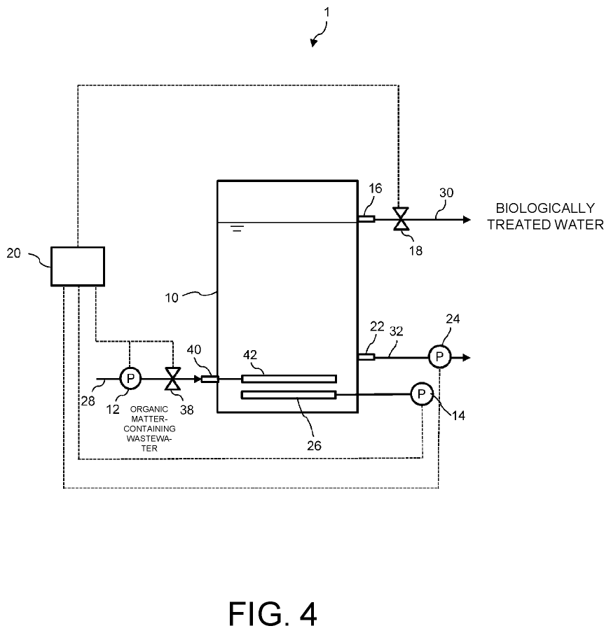

For stable formation of granules, it is important to control the ratio between the period of feast state during which organic matter-containing wastewater fed into the semi-batch reaction tank 10 has a high organic matter concentration, and the period of famine state during which decomposition of organic matter by microbial sludge has proceeded and the organic matter-containing wastewater has a low organic matter concentration. This relationship between the period of feast and the period of famine can be indirectly controlled using the ratio of the MLSS concentration in the semi-batch reaction tank 10 relative to the BOD load in the semi-batch reaction tank 10. Further, since the processes other than the biological treatment process do not significantly contribute to biological reaction, the ratio of (period of feast/period of famine) can be more precisely controlled by performing evaluation using a value obtained by multiplying the ratio of the MLSS concentration relative to the BOD load by [the duration of the operation cycle/the duration of the biological treatment process]. Here, the “duration of the operation cycle” denotes the total time of the above (1) feed process, (2) biological treatment process, (3) settling process, and (4) discharge process (or, in the cases of the configurations of FIGS. 3 and 4 described below, the total time of (1) simultaneous feed and discharge process, (2) biological treatment process, and (3) settling process).

However, in cases where the organic matter-containing wastewater contains a large amount of slowly degradable organic matter, if the duration of the biological treatment process is decided by employing, as the ratio of the MLSS concentration relative to the BOD load, the ratio of the MLSS concentration relative to the total BOD load, the balance between the state of feast and the state of famine in the operation cycle becomes lost, making it difficult to achieve stable formation of granules. In this light, the present inventors have found, as a result of intensive studies, that in cases where the organic matter-containing wastewater contains a large amount of slowly degradable organic matter, in terms of stable formation of granules, it is important to decide the duration of the biological treatment process by employing the ratio of the MLSS concentration relative to the BOD load of readily degradable organic matter. More specifically, the present inventors have found that stable formation of granules is possible by adjusting the duration of the biological treatment process such that a value (hereinafter may be referred to as “value A”) obtained when the ratio of the MLSS concentration in the semi-batch reaction tank 10 relative to the BOD load of readily degradable organic matter in the semi-batch reaction tank 10 (i.e., the BOD load of readily degradable organic matter/MLSS) is multiplied by [the duration of the operation cycle/the duration of the biological treatment process] is in the range of 0.05 to 0.25 kg-BOD/kg-MLSS/day.

The “value A” is preferably in the range of 0.05 to 0.25 kg-BOD/kg-MLSS/d, and more preferably in the range of 0.075 to 0.2 kg-BOD/kg-MLSS/d. When this value is less than 0.05 kg-BOD/kg-MLSS/d, an appropriate state of feast and an appropriate state of famine cannot be created, making it difficult to achieve stable formation of granules. On the other hand, when this value is greater than 0.25 kg-BOD/kg-MLSS/d, the period of famine becomes too short, making it difficult to achieve stable formation of granules.

Methods for calculating the BOD load of readily degradable organic matter will now be described. The following calculation methods are examples, and the examples below do not serve as limitations.

### <Calculation Example 1 for Calculating BOD Load of Readily Degradable Organic Matter>

Time shift of the oxygen consumption rate with the microbial sludge using the organic matter-containing wastewater are measured. The oxygen consumption rate is determined by a known OUR (oxygen uptake rate) test. The OUR test is carried out, for example, by mixing the wastewater and the microbial sludge to cause reaction batchwise, and measuring the oxygen consumption rate with the microbial sludge over time. The microbial sludge used for the OUR test is preferably sufficiently acclimated to the test wastewater. When a well-acclimated microbial sludge is used, the oxygen consumption rate reaches its highest value immediately after the start of the test, and then gradually decreases. This is because the degradation rate of readily degradable organic matter in the organic matter-containing wastewater is high, so that, with elapse of time, the amount of the readily degradable organic matter decreases and the proportion of the slowly degradable organic matter increases.

Subsequently, each value of oxygen consumption rate measured as necessary is divided by the sludge concentration of the test sludge, and time shift of the oxygen consumption rate per microbial sludge are thereby obtained. For example, a period during which the oxygen consumption rate per microbial sludge is maintained at 0.4 kg-O₂/kg-MLVSS/d or higher is determined as the period during which readily degradable organic matter is remaining, and it is assumed that the cumulative oxygen consumption up to and during that period is the BOD concentration of readily degradable organic matter. By multiplying the assumed BOD concentration of readily degradable organic matter by the amount of organic matter-containing wastewater to be put into the semi-batch reaction tank, the BOD load of readily degradable organic matter is calculated.

### <Calculation Example 2 for Calculating BOD Load of Readily Degradable Organic Matter>

Since solid organic matter can be mentioned as a typical example of slowly degradable organic matter, when the wastewater contains organic SS component at a high concentration, the BOD concentration of slowly degradable organic matter may be calculated from a formula (which may be a map, table, or the like) that defines a relationship determined in advance between the BOD concentration of that slowly degradable organic matter and the organic SS component. Subsequently, the calculated BOD concentration of slowly degradable organic matter may be subtracted from the separately measured total BOD concentration so as to obtain the BOD concentration of readily degradable organic matter, and the BOD load of readily degradable organic matter may thereby be calculated. In this case, a means (an SS meter, turbidity meter, or the like) for measuring the organic SS component in the wastewater may be provided, and by monitoring its concentration, the concentration of slowly degradable organic matter can be on-line determined. This calculation method is suitable for wastewater with an SS concentration of 100 mg/L or higher, and is particularly effective when raw sewage (i.e., inflow sewage not subjected to pretreatment such as sedimentation) is dealt with as target wastewater.

### <Calculation Example 3 for Calculating BOD Load of Easily Degradable Organic Matter>

In the case of wastewater in which the ratio of slowly degradable organic matter and readily degradable organic matter in the wastewater does not fluctuate significantly, the BOD concentration of readily degradable organic matter (or the BOD concentration of slowly degradable organic matter) may be determined from a formula (which may be a map, table, or the like) that defines a relationship determined in advance between the BOD concentration of readily degradable organic matter (or the BOD concentration of slowly degradable organic matter) and the COD concentration or TOC concentration, and the BOD load of readily degradable organic matter may thereby be calculated. In this case, a means for measuring the COD concentration or TOC concentration of the organic matter-containing wastewater fed into the semi-batch reaction tank may be provided, and by monitoring the concentration, the BOD concentration of readily degradable organic matter (or the BOD concentration of slowly degradable organic matter) can be on-line determined.

The sludge retention time (SRT) in the semi-batch reaction tank 10 is preferably in the range of 5 to 25 days, and more preferably in the range of 10 to 15 days, in terms of stable formation of granules. For example, the sludge removal pump 24 shown in FIGS. 1 and 2 is actuated to remove sludge from the sludge removal port 22 and through the sludge removal pipe 32 such that the SRT is in the range of 5 to 25 days. When the “value A” is less than 0.05, the proportion of proliferative microorganisms is small and the amount of sludge removal cannot be increased, so that there is difficulty in making the SRT longer than 30 days, and about 25 days is the limit.

The SRT is represented by the following formula.

SRT [d]=Amount of sludge present in tank [kg]/Amount of sludge discharged out of system per day [kg/d]

The MLSS concentration in the semi-batch reaction tank 10 is preferably in the range of 1,500 to 10,000 mg/L, and more preferably in the range of 3,000 to 8,000 mg/L, in terms of stable formation of granules, although this depends on the total BOD load.

Further, a value obtained when the ratio of the MLSS concentration relative to the total BOD load (including the BOD load of slowly degradable organic matter and readily degradable organic matter) in the semi-batch reaction tank 10 is multiplied by [the duration of the operation cycle/the duration of the biological treatment process] is preferably in the range of 1.0 kg-BOD/kg-MLSS/d or less, and more preferably in the range of 0.5 kg-BOD/kg-MLSS/d or less. When this value is 1.0 kg-BOD/kg-MLSS/d or greater, undegraded BOD components may accumulate in the sludge inside the reaction tank and may deteriorate the settling property, or difficulty in forming and maintaining granules may result due to generation of filamentous bacteria or the like that cause poor sludge sedimentation.

Organic matter-containing wastewater that serves as a target of treatment by the granule forming method according to the present embodiment is organic wastewater that contains biodegradable organic matter, such as food processing plant wastewater, chemical plant wastewater, semiconductor plant wastewater, machine factory wastewater, sewage, and human waste. Further, when wastewater contains hardly biodegradable organic matter, by performing in advance a physicochemical treatment such as ozone treatment or Fenton treatment to carry out conversion into biodegradable component, the wastewater can be handled as a target of treatment. Although the granule forming method according to the present embodiment is intended for various BOD components, oil and fat components may exert an adverse effect by adhering to the sludge and granules. Accordingly, before being introduced into the semi-batch reaction tank 10, oil and fat components are preferably removed, for example, to about 150 mg/L or less in advance by existing techniques such as flotation separation, coagulation and pressure flotation, adsorption, and the like.

The pH in the semi-batch reaction tank 10 is preferably set in a range suitable for general microorganisms. For example, the pH is preferably in the range of 6 to 9, and more preferably in the range of 6.5 to 7.5. When the pH value is outside the above-noted range, pH control is preferably performed by adding an acid, an alkali, or the like.

Dissolved oxygen (DO) in the semi-batch reaction tank 10 under aerobic conditions is preferably 0.5 mg/L or more, and particularly preferably 1 mg/L or more.

In terms of promoting granulation of microbial sludge, it is preferable to add ions that form hydroxides, including Fe²⁺, Fe³⁺, Ca²⁺, Mg²⁺, and the like, to the organic matter-containing wastewater in the semi-batch reaction tank 10, or to the organic matter-containing wastewater before being introduced into the semi-batch reaction tank 10. Although ordinary organic matter-containing wastewater contains fine particles that serve as cores of granules, addition of the above-noted ions makes it possible to promote formation of cores of granules.

A further example of the granule forming apparatus according to the present embodiment is shown in FIG. 3. In the granule forming apparatus 1 of FIG. 3, a wastewater supply pipe 28 is connected to a wastewater inlet 40 at a lower part of a semi-batch reaction tank 10 via a wastewater feed pump 12 and a wastewater feed valve 38. A wastewater output section 42 is connected to the wastewater inlet 40 and installed at a lower part of the interior of the semi-batch reaction tank 10. A biologically treated water outlet 16 of the semi-batch reaction tank 10 is provided at a position higher than the wastewater inlet 40, and a biologically treated water pipe 30 is connected to the biologically treated water outlet 16 via a biologically treated water discharge valve 18. While the biologically treated water outlet 16 is provided at a position higher than the wastewater inlet 40, in order to prevent incoming organic matter-containing wastewater from short-circuiting and to allow granules to be formed more efficiently, the biologically treated water outlet 16 is preferably located as far as possible from the wastewater inlet 40, and more preferably provided at the water surface level in the settling process. A control device 20 is, for example, electrically connected to each of the wastewater feed pump 12, the wastewater feed valve 38, the biologically treated water discharge valve 18, a sludge removal pump 24, an aeration pump 14, and a motor 34 of a stirring device. In other respects, the configuration is the same as that of the granule forming apparatus 1 of FIG. 2.

In the granule forming apparatus 1 of FIG. 3, in (4) the discharge process, the wastewater feed valve 38 is opened and the wastewater feed pump 12 is actuated, so that the organic matter-containing wastewater is fed from the wastewater inlet 40 through the wastewater supply pipe 28 and into the semi-batch reaction tank 10 from the wastewater output section 42. By doing so, biologically treated water is discharged from the biologically treated water outlet 16 and through the biologically treated water pipe 30.

As such, in the granule forming apparatus 1 of FIG. 3, granules are formed by repeating (1) the feed and discharge process, (2) the biological treatment process, and (3) the settling process. This configuration of repeating the processes (1) to (3) is one form of the operation cycle including the feed process, the biological treatment process, the settling process, and the discharge process.

In the granule forming apparatus 1 of FIG. 3, since biologically treated water is discharged from the biologically treated water outlet 16 by feeding organic matter-containing wastewater into the semi-batch reaction tank 10, granules having a relatively small particle size are discharged together with the biologically treated water, and the processes (1) to (3) are repeated for granules having a relatively large particle size. As a result, granules can be formed more efficiently.

The wastewater feed ratio in the feed and discharge process is preferably in the range of, for example, 10% or higher and 100% or lower. The wastewater feed ratio is the ratio of the amount of water to be treated that is fed in one operation cycle relative to the effective volume inside the semi-batch reaction tank 10. Here, in order to increase the concentration of the target substance to be treated remaining in the semi-batch reaction tank 10, it is better to set the feed ratio of the water to be treated as high as possible. However, when the wastewater feed ratio is set higher, there is a greater concern that the quality of treated water will become deteriorated due to short-circuiting of the water to be treated. Accordingly, in view of these factors, the wastewater feed ratio is preferably in the range of 20% or higher and 80% or lower. Nevertheless, so long as a treatment device such as an activated sludge tank is provided at a point downstream of the semi-batch reaction tank 10 and the water quality of the final treated water obtained after this downstream treatment device is not deteriorated, no particular limitation is imposed on the wastewater feed ratio, and, for example, setting to higher than 100% is also possible. In cases where the wastewater feed ratio is set higher than 100%, the upper limit of the wastewater feed ratio is preferably set to 200% or lower in order to suppress a decrease in the number of operation cycles.

The duration of the feed and discharge process is decided according to, for example, the wastewater feed ratio and the flow rate of water to be treated into the semi-batch reaction tank 10. When the overflow rate of the semi-batch reaction tank 10, which is a value obtained by dividing the flow rate of wastewater into the semi-batch reaction tank 10 by the horizontal cross-sectional area of the semi-batch reaction tank 10, is set high, it is possible to selectively discharge a lightweight sludge portion of the sludge out of the system and to allow a sludge portion with high settling property to remain in the tank. For this reason, although formation of biological sludge with high settling property is promoted, during a start-up period or the like when the settling property of the sludge is not high, there is concern that the sludge in the tank will flow out and the biological treatment function will become deteriorated. On the other hand, when the overflow rate of the semi-batch reaction tank 10 is set low, the sludge selection effect becomes low, and when, in addition, the wastewater feed ratio is increased, there is concern that the duration of the feed/discharge process will become long and difficulty occurs in forming sludge with high settling property. In view of the above circumstances, the overflow rate of the semi-batch reaction tank 10 is preferably 0.5 m/h or higher and 20 m/h or lower, and is preferably in the range of 1 m/h or higher and 10 m/h or lower. Further, when it becomes possible to set the overflow rate of the semi-batch reaction tank 10 higher as a result of improvement of the settling property of the biological sludge in the tank, the overflow rate of the semi-batch reaction tank 10 can be increased depending on the settling property of the biological sludge, and the duration of the feed/discharge process can be reduced depending on the overflow rate and the feed ratio of water to be treated.

A further example of the aerobic granule forming apparatus according to the present embodiment is shown in FIG. 4. In the granule forming apparatus 1 of FIG. 4, a wastewater supply pipe 28 is connected to a wastewater inlet 40 at a lower part of a semi-batch reaction tank 10 via a wastewater feed pump 12 and a wastewater feed valve 38. A wastewater output section 42 is connected to the wastewater inlet 40 and installed at a lower part of the interior of the semi-batch reaction tank 10. A biologically treated water outlet 16 of the semi-batch reaction tank 10 is provided at a position higher than the wastewater inlet 40, and a biologically treated water pipe 30 is connected to the biologically treated water outlet 16 via a biologically treated water discharge valve 18. While the biologically treated water outlet 16 is provided at a position higher than the wastewater inlet 40, in order to prevent incoming organic matter-containing wastewater from short-circuiting and to allow granules to be formed more efficiently, the biologically treated water outlet 16 is preferably located as far as possible from the wastewater inlet 40, and more preferably provided at the water surface level in the settling process. A control device 20 is, for example, electrically connected to each of the wastewater feed pump 12, the wastewater feed valve 38, the biologically treated water discharge valve 18, a sludge removal pump 24, and an aeration pump 14. In other respects, the configuration is the same as that of the granule forming apparatus 1 of FIG. 1.

In the granule forming apparatus 1 of FIG. 4, in (4) the discharge process, the wastewater feed valve 38 is opened and the wastewater feed pump 12 is actuated, so that the organic matter-containing wastewater is fed from the wastewater inlet 40 through the wastewater supply pipe 28 and into the semi-batch reaction tank 10 from the wastewater output section 42. By doing so, biologically treated water is discharged from the biologically treated water outlet 16 and through the biologically treated water pipe 30.

The actuation and stopping of the wastewater feed pump 12, the sludge removal pump 24, and the aeration pump 14, and also the opening and closing of the wastewater feed valve 38 and the biologically treated water discharge valve 18, may be controlled by the control device 20.

As such, in the granule forming apparatus 1 of FIG. 4 as well, granules are formed by repeating (1) the feed and discharge process, (2) the biological treatment process, and (3) the settling process.

### <Wastewater Treatment Method and Wastewater Treatment Apparatus>

A wastewater treatment apparatus according to the present embodiment comprises a continuous biological treatment tank in which organic matter-containing wastewater is biologically treated with biological sludge while the organic matter-containing wastewater is continuously fed thereinto. In a wastewater treatment method and the wastewater treatment apparatus according to the present embodiment, granules formed by the above-described aerobic granule forming method is supplied to the continuous biological treatment tank in which organic matter-containing wastewater is biologically treated with biological sludge while the organic matter-containing wastewater is continuously fed thereinto.

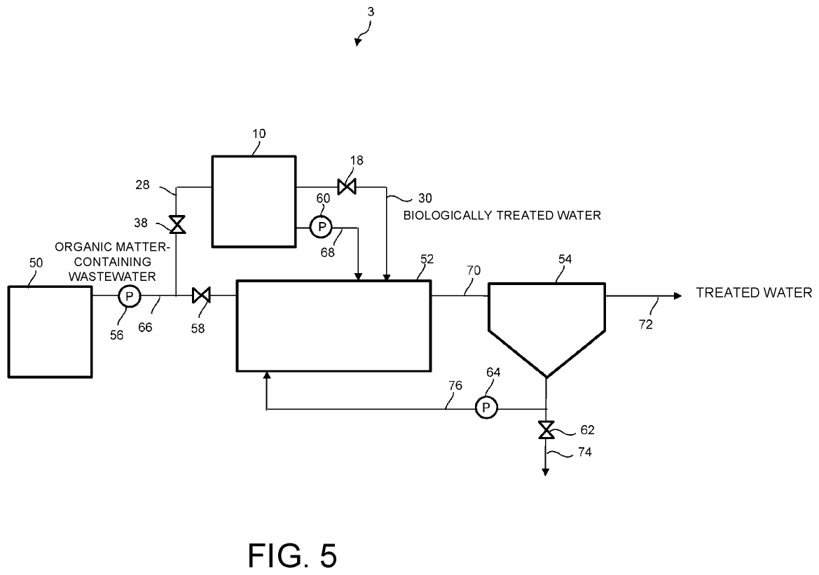

FIG. 5 shows a schematic configuration of an example wastewater treatment apparatus according to the present embodiment. The wastewater treatment apparatus 3 comprises a wastewater storage tank 50, a semi-batch reaction tank 10, a continuous biological treatment tank 52, and a solid-liquid separation device 54.

In the wastewater treatment apparatus 3, an outlet of the wastewater storage tank 50 and a wastewater inlet of the continuous biological treatment tank 52 are connected by a wastewater supply pipe 66 via a pump 56 and a valve 58. An outlet of the continuous biological treatment tank 52 and an inlet of the solid-liquid separation device 54 are connected by a pipe 70. A treated water pipe 72 is connected to a treated water outlet of the solid-liquid separation device 54. A sludge discharge pipe 74 is connected to a sludge outlet of the solid-liquid separation device 54 via a valve 62, and a part of the sludge discharge pipe 74 located upstream of the valve 62 is connected to a return sludge inlet of the continuous biological treatment tank 52 by a sludge return pipe 76 via a pump 64. A part of the wastewater supply pipe 66 between the pump 56 and the valve 58 is connected to a wastewater inlet of the semi-batch reaction tank 10 by a wastewater supply pipe 28 via a wastewater feed valve 38. A biologically treated water outlet of the semi-batch reaction tank 10 and a biologically treated water inlet of the continuous biological treatment tank 52 are connected by a biologically treated water pipe 30 via a biologically treated water discharge valve 18. A sludge outlet of the semi-batch reaction tank 10 and a sludge inlet of the continuous biological treatment tank 52 are connected by a sludge pipe 68 via a pump 60.

The continuous biological treatment tank 52 comprises, for example, a stirring device, an aeration pump, an aeration device connected to the aeration pump, and the like, and is configured such that oxygen-containing gas, such as air, that is supplied by the aeration pump is supplied into the tank through the aeration device.

The solid-liquid separation device 54 is a separation device for separating biological sludge and treated water from treated water containing biological sludge, and examples thereof include separation devices that perform sedimentation separation, pressure flotation, filtration, membrane separation, and the like.

In the wastewater treatment apparatus 3, first, the valve 58 is opened, the pump 56 is actuated, and organic matter-containing wastewater in the wastewater storage tank 50 is supplied to the continuous biological treatment tank 52 through the wastewater supply pipe 66. In the continuous biological treatment tank 52, biological treatment of the wastewater with biological sludge is performed under aerobic conditions (continuous biological treatment process). Treated water that has been treated in the continuous biological treatment tank 52 is supplied from the outlet of the continuous biological treatment tank 52 to the solid-liquid separation device 54 through the pipe 70. In the solid-liquid separation device 54, biological sludge is separated from the treated water (solid-liquid separation process). The treated water that has been subjected to solid-liquid separation treatment is discharged out of the system from the treated water outlet of the solid-liquid separation device 54 and through the treated water pipe 72. The biological sludge separated by solid-liquid separation is discharged out of the system through the sludge discharge pipe 74 by opening the valve 62. At least part of the biological sludge separated by solid-liquid separation may be returned to the continuous biological treatment tank 52 through the sludge return pipe 76 by actuating the pump 64.

When operating the semi-batch reaction tank 10, the wastewater feed valve 38 is opened, and at least part of the organic matter-containing wastewater in the wastewater storage tank 50 is supplied to the semi-batch reaction tank 10 through the wastewater supply pipe 28. In the semi-batch reaction tank 10, granules are formed by repeating the operation cycle including the above-described (1) feed process, (2) biological treatment process, (3) settling process, and (4) discharge process (or the operation cycle including the (1) feed process/discharge process, (2) biological treatment process, and (3) settling process), and the formed granules may be supplied to the continuous biological treatment tank 52 through the sludge pipe 68 by actuating the pump 60.

The continuous biological treatment tank 52 shown in FIG. 5 has been described above by referring, as an example, to a configuration in which biological treatment is performed by a standard activated sludge process intended to treat organic matter and the like. However, the continuous biological treatment tank 52 is not limited to this configuration, and for example, it is possible to use an apparatus that carries out biological treatment using a system such as a nutrient removal system that performs A2O (anaerobic-anoxic-oxic process) or AO (anaerobic-oxic process) (a system that involves installing an anoxic treatment tank and an anaerobic treatment tank), or a system that performs an oxidation ditch process, a step-feed multi-stage activated sludge process, or the like. It is also possible to use an apparatus that carries out biological treatment in the presence of a carrier made of polyurethane, plastic, resin, or the like.

Although the wastewater treatment apparatus 3 shown in FIG. 5 has been described above by referring, as an example, to a configuration including the solid-liquid separation device 54, the solid-liquid separation device 54 is not necessarily included. However, in terms of improving wastewater treatment efficiency by circulating granules, the wastewater treatment device 3 preferably includes the solid-liquid separation device 54 for separating the biological sludge from the treated water discharged from the continuous biological treatment tank 52, and the sludge return pipe 76 for returning the biological sludge discharged from the solid-liquid separation device 54 to the continuous biological treatment tank 52.

### EXAMPLES

While the present disclosure will be described below in more specific detail by referring to Examples and Comparative Examples, the present disclosure is not limited to the Examples below.

A water flow test was carried out using a semi-batch reaction tank with a reaction tank effective volume of 33 L (125 mm×438 mm×effective water depth of 600 mm). Evaluation was performed using values of SVI5 and SVI30 as indices of granulation. An SVI is an index of settling property of biological sludge, and is determined by the following method. First, 1 L of sludge is put into a 1-L graduated cylinder, gently stirred such that the sludge concentration becomes as uniform as possible, then left to stand for 5 minutes, after which the sludge interface is measured. Then, the ratio of volume (%) occupied by the sludge in the graduated cylinder is calculated. Next, the MLSS (mg/L) of the sludge is measured. These values are substituted into the following formula to calculate SVI5. A smaller SVI5 value indicates that the sludge has a higher settling property.

$$SVI 5 ( mL / g ) = Ratio of volume occupied by sludge \times 10 , 000 / MLSS$$

(When calculating SVI30, the leaving to stand for 5 minutes is changed to leaving to stand for 30 minutes.)

Wastewater used was raw sewage that flowed into a sewage treatment plant, and was used without being subjected to sedimentation treatment but after being pretreated with a coarse screen having a mesh aperture size of 2 mm. Table 1 shows the total BOD concentration, the BOD concentration of easily degradable matter, and the BOD concentration of slowly degradable matter of the raw sewage during the test period. The ratio of the BOD concentration of slowly degradable matter relative to the total BOD concentration of the raw sewage was 0.5 or higher throughout the test period.

TABLE 1

| | | BOD Concentration | BOD Concentration |
|---|---|---|---|
| | Total BOD | of Readily | of Slowly |
| | Concen- | Degradable | Degradable |
| | tration | Organic Matter | Organic Matter |
| | mg/L | mg/L | mg/L |
| Average Value | 345 | 72 | 272 |
| Standard | 162 | 26 | 167 |
| Deviation | | | |
| Maximum | 928 | 135 | 840 |
| Minimum | 72 | 19 | 40 |

A cycle of operation of the semi-batch reaction tank was performed as described below.
(1) Feed and discharge process: Wastewater was introduced into the semi-batch reaction tank over a period of 50 minutes, and supernatant water was discharged as treated water. The wastewater feed ratio was 100%.
(2) Biological treatment process: The duration of the biological treatment process was set such that a value (i.e., the value A in the formula below) obtained when the ratio of the MLSS concentration relative to the BOD load of easily degradable organic matter in the semi-batch reaction tank was multiplied by [the duration of the operation cycle/the duration of the biological treatment process] became equal to each of the values shown in Table 2. For the set durations, the biological treatment process was performed by supplying air from the aeration device installed at a lower part of the semi-batch reaction tank.
(3) Settling process: The supplying of air from the aeration device was stopped, and sludge in the semi-batch reaction tank was allowed to settle by being left to stand for between 15 and 30 minutes.

The operation cycle including the above (1) to (3), which served as one cycle, was repeated.

The value (the value A) obtained when the ratio of the MLSS concentration relative to the BOD load of readily degradable organic matter in the semi-batch reaction tank is multiplied by [the duration of the operation cycle/the duration of the biological treatment process] is calculated, for example, as follows.

$$A = ( ( ( B - C ) / 1000 \times ( H \times D / 100 \times G ) ) / ( I / 1000 \times H ) ) \times ( F / E )$$

where
B=BOD concentration of readily degradable matter in wastewater [mg/L]
C=BOD concentration of readily degradable matter after treatment [mg/L]
D=Proportion of wastewater introduced relative to effective volume of reaction tank per cycle [%]
E=Duration of biological treatment process per cycle [min]
F=Total process time of one cycle [min]
G=Number of cycles per day [times/day]
H=Effective volume of reaction tank [m³]
I=MLSS [mg/L]

### <Conditions of Biological Treatment Process>

TABLE 2

| | | | Duration of | |
|---|---|---|---|---|
| | | Value A | Biological | |
| | Period | [kg-BOD/ | Treatment Process | MLSS |
| | [days] | kg-MLSS/day] | Per Cycle [min] | [mg/L] |
| Condition 1 | 0-30 | 0.04-less than | 450 | 4000-5000 |
| | | 0.05 | | |
| Condition 2 | 30-70 | 0.02-less than | 600-720 | 5000-6000 |
| | | 0.05 | | |
| Condition 3 | 0-40 | 0.05-0.1 | 450 | 3500 |
| Condition 4 | 40-55 | 0.075-0.125 | 300-350 | 4000 |

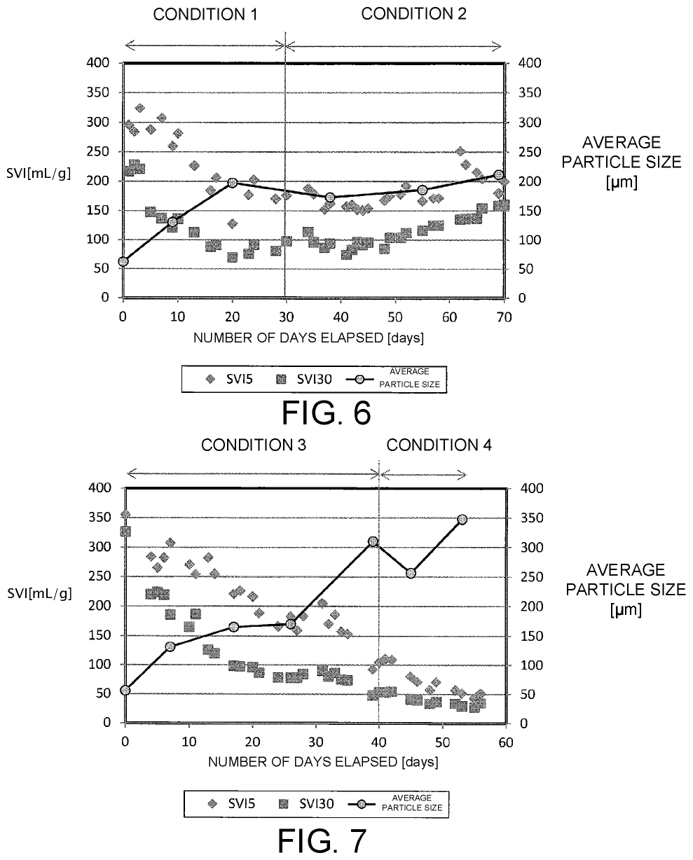

FIG. 6 shows time courses of SVI and sludge average particle size under Conditions 1 and 2 (i.e., Comparative Examples) in Table 2, and FIG. 7 shows time courses of SVI and sludge average particle size under Conditions 3 and 4 (i.e., Examples) in Table 2.

During the period of Condition 1, operation was performed such that MLSS was in the range of 3000 to 4000 mg/L, and the duration of the biological treatment process was set such that the value A was 0.04 to less than 0.05 kg-BOD/kg-MLSS/day. As a result, by the 20th day from the start of water flow, SVI30 decreased to about 80 mL/g and SVI5 decreased to 170 mg/L. Further, the particle size of the microbial sludge increased, and the average particle size became 200 μm. However, from the 20th day onward, the decrease in SVI and the increase in particle size of the microbial sludge became stagnant.

During the period of Condition 2, operation was performed such that MLSS was in the range of 5000 to 6000 mg/L, and the duration of the biological treatment process was set such that the value A was 0.02 to less than 0.05 kg-BOD/kg-MLSS/day. As a result, from about 40 days after the start of water flow, an increase in SVI was observed. During the period of Condition 2, there was hardly any change in particle size of the microbial sludge.

In the period of Condition 3, operation was performed such that MLSS was about 3500 mg/L, and the duration of the biological treatment process was set such that the value A was 0.05 to 0.1 kg-BOD/kg-MLSS/day. As a result, SVI5 decreased to about 100 mL/g. Further, the particle size of the microbial sludge increased, and the average particle size became 300 μm.

In the period of Condition 4, operation was performed such that MLSS was about 4000 to 5000 mg/L, and the duration of the biological treatment process was set such that the value A was 0.075 to 0.125 kg-BOD/kg-MLSS/day. As a result, SVI5 decreased to about 40 mL/g, and SVI30 decreased to about 30 mL/g. Further, the particle size of the microbial sludge increased, and the average particle size became 350 μm.

### REFERENCE SIGNS LIST

1 granule forming apparatus; 3 wastewater treatment apparatus; 10 semi-batch reaction tank; 12 wastewater feed pump; 14 aeration pump; 16 biologically treated water outlet; 18 biologically treated water discharge valve; 20 control device; 22 sludge removal port; 24 sludge removal pump; 26 aeration device; 28, 66 wastewater supply pipe; 30 biologically treated water pipe; 32 sludge removal pipe; 34 motor; 36 stirring blade; 38 wastewater feed valve; 40 wastewater inlet; 42 wastewater output section; 50 wastewater storage tank; 52 continuous biological treatment tank; 54 solid-liquid separation device; 56, 60, 64 pump; 58, 62 valve; 68 sludge pipe; 70 pipe; 72 treated water pipe; 74 sludge discharge pipe; 76 sludge return pipe.

1. An aerobic granule forming method using a semi-batch reaction tank in which aerobic granules are formed by performing an operation cycle including: a feed process of feeding organic matter-containing wastewater; a biological treatment process of biologically treating organic matter in the wastewater with microbial sludge; a settling process of allowing settling of the microbial sludge; and a discharge process of discharging treated water that has been subjected to the biological treatment, wherein
the organic matter includes readily degradable organic matter and slowly degradable organic matter, and
a duration of the biological treatment process is adjusted such that a value obtained when a ratio of MLSS concentration in the semi-batch reaction tank relative to BOD load of the readily degradable organic matter in the semi-batch reaction tank is multiplied by [a duration of the operation cycle/the duration of the biological treatment process] is in a range of 0.05 to 0.25 kg-BOD/kg-MLSS/day.

2. The aerobic granule forming method according to claim 1, wherein a ratio of BOD concentration of the slowly degradable organic matter in the organic matter-containing wastewater relative to total BOD concentration of the organic matter-containing wastewater fed into the semi-batch reaction tank is 0.5 or higher.

3. The aerobic granule forming method according to claim 1, wherein a biologically treated water outlet of the semi-batch reaction tank is provided at a position higher than a wastewater inlet, and simultaneously the biologically treated water is discharged from the biologically treated water outlet by feeding the organic matter-containing wastewater into the semi-batch reaction tank from the wastewater inlet.

4. An aerobic granule forming apparatus having a semi-batch reaction tank in which aerobic granules are formed by performing an operation cycle including: a feed process of feeding organic matter-containing wastewater; a biological treatment process of biologically treating organic matter in the wastewater with microbial sludge; a settling process of allowing settling of the microbial sludge; and a discharge process of discharging treated water that has been subjected to the biological treatment, wherein
the organic matter includes readily degradable organic matter and slowly degradable organic matter, and
the aerobic granule forming apparatus comprises a means for adjusting a duration of the biological treatment process such that a value obtained when a ratio of MLSS concentration in the semi-batch reaction tank relative to BOD load of the readily degradable organic matter in the semi-batch reaction tank is multiplied by [a duration of the operation cycle/the duration of the biological treatment process] is in a range of 0.05 to 0.25 kg-BOD/kg-MLSS/day.
